(19) United States
(12) Patent Application Publication
(10) Pub. No.: US 2015/0049325 A1
(43) Pub. Date: Feb. 19, 2015

(54) Wearable user-controlled obstacle identification and notification system for hands-free navigation

(71) Applicant: Shiloh S.S. Curtis, Sunnyvale, CA (US)

(72) Inventor: Shiloh S.S. Curtis, Sunnyvale, CA (US)

(21) Appl. No.: 14/121,152

(22) Filed: Aug. 7, 2014

Related U.S. Application Data
(60) Provisional application No. 61/959,215, filed on Aug. 19, 2013.

(51) Int. Cl. G01S 17/93; G01S 13/00; A42B 1/24; G01S 3/04

(52) U.S. Cl. CPC G01S 17/93; G01S 3/046; G01S 13/00; A42B 1/245
USPC 356/4.01; 702/150

(57) ABSTRACT

An obstacle identification and notification system comprised of a wearable item 10 upon which sensor(s) 12 are mounted. The sensor(s) 12 gather information about obstacles in the environment. The sensor(s) 12 are coupled to a microprocessor 16, which analyzes the information transmitted about an obstacle. The microprocessor 16 is coupled to a feedback system 22. The feedback system 22 provides information to the user about the obstacle through tactile, auditory or visual means through a scheduling system. The user may control the feedback system through a user interface element 34.

### CROSS-REFERENCE TO RELATED APPLICATIONS

This application claims the benefit of U.S. Provisional Application No. 61/959,215, filed Aug. 19, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Humans face numerous situations where a wearable user-controlled obstacle identification and notification system for hands-free navigation would be of navigational assistance in detecting obstacles in the vicinity of a person equipped with the system, including, but not limited to, situations where they face multiple demands on their attention, their hearing, their vision, their strength, or their hands and arms. These situations may include, but are not limited to, various physical disabilities or infirmities.

### BRIEF SUMMARY OF THE INVENTION

The present invention is a wearable user-controlled obstacle identification and notification system for hands-free navigation. Said system comprises sensor(s), which may include, but are not limited to, lidar, sonar, radar, or ultrasonic sensors. In said system, the sensor(s) are coupled to a microprocessor which analyzes the sensor output. In said system, the microprocessor then communicates obstacle presence, distance, size, shape, and other characteristics to the user via a feedback device. In said system, the feedback device communicates obstacle information via visual, auditory and/or tactile output to the user. Visual feedback devices used in said invention may include, but are not limited to, all manners of cameras. Auditory feedback devices used in said system may include, but are not limited, to voice coils. Tactile feedback devices used in said system may include, but are not limited to, vibrating motors, heating devices, cooling devices, bladder devices, or linear actuators. Said system is mounted to a wearable item. Wearable items used in said system may include, but are not limited to, apparel, clothing, headwear, footwear, accessories, jewelry, or watches. Said system also comprises a user interface control whereby the user may control the intensity of the feedback provided by said system.

### BRIEF DESCRIPTION OF THE SEVERAL VIEWS OF THE DRAWING

These and other more detailed and specific objects and features of the present invention are more fully disclosed in the following specification, reference being had to the accompanying drawings, in which:

FIG. 1 is a three dimensional view of one preferred exemplary embodiment of the present invention.

FIG. 2 is a cross-sectional view of one preferred exemplary embodiment of the present invention.

FIG. 3 is a block diagram of one preferred exemplary embodiment of the present invention.

FIG. 4A is a top view the tactile stimulator array element of one preferred exemplary embodiment of the present invention.

FIG. 4B is a perspective view of the tactile stimulator array element of one preferred exemplary embodiment of the present invention.

FIG. 4C is a top view of an individual tactile stimulator in the tactile stimulator array element of one preferred exemplary embodiment of the present invention.

FIG. 4D is a side view of an individual tactile stimulator in the tactile stimulator array element of one preferred exemplary embodiment of the present invention.

### DETAILED DESCRIPTION OF THE INVENTION

The following detailed description refers to the accompanying drawings that depict various details of examples selected to show how particular exemplary embodiments may be implemented. The discussion herein addresses various examples of the inventive subject matter at least partially in reference to these drawings and describes the depicted exemplary embodiments in sufficient detail to enable those skilled in the art to practice the invention. Many other exemplary embodiments may be utilized for practicing the inventive subject matter than the illustrative examples discussed herein, and many structural and operational changes in addition to the alternatives specifically discussed herein may be made without departing from the scope of the inventive subject matter.

In this description, references to “one exemplary embodiment” or “an exemplary embodiment” or to “one example” or “an example” mean that the feature being referred to is, or may be, included in at least one exemplary embodiment or example of the invention. Separate references to “an exemplary embodiment” or “one exemplary embodiment” or to “one example” or “an example” in this description are not intended to necessarily refer to the same exemplary embodiment or example; however, neither are such exemplary embodiments mutually exclusive, unless so stated or as will be readily apparent to those of ordinary skill in the art having the benefit of this disclosure. Thus, the present invention includes a variety of combinations and/or integrations of the exemplary embodiments and examples described herein, as well as further exemplary embodiments and examples as defined with the scope of all claims based on this disclosure, as well as all legal equivalents of such claims.

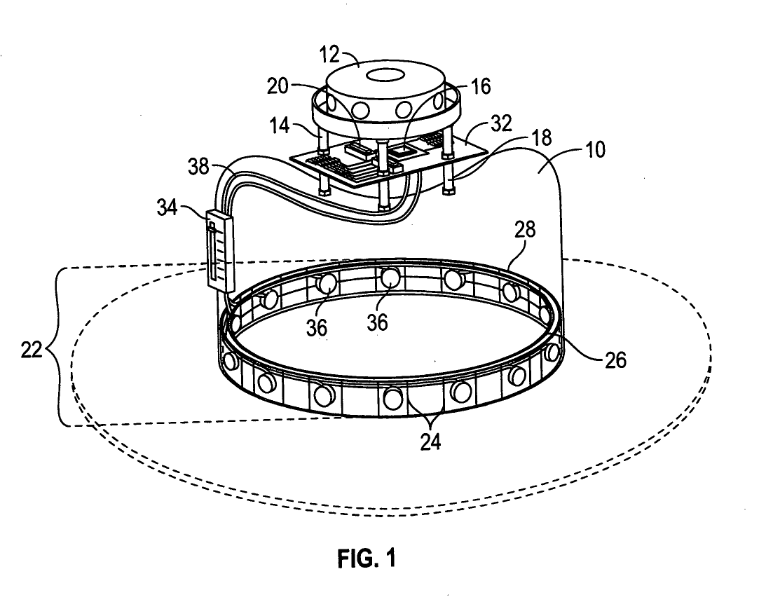

FIG. 1 is a three dimensional view of one exemplary embodiment of the present invention. The wearable item in this exemplary embodiment is an item of headwear 10. In the exemplary embodiment of the obstacle identification system, the headwear 10 may be replaced with one or more items of apparel, clothing, headwear, footwear, accessories, jewelry, or watches, each item of which may be equipped with sensor(s) 12.

The wearable item 10 includes sensor(s) 12. In one exemplary embodiment of the present invention, the sensor is a lidar or laser distance scanner 12, which is included on the headwear via coupling 14. In one exemplary embodiment of the present invention, the lidar or laser distance scanner 12 may be replaced with sonar, radar, or ultrasonic sensors.

One preferred lidar sensor 12 for one exemplary embodiment is a non-contact laser distance scanner that provides bearing and range information. The minimum desired range is 1.5 meters, with the preferred range being 2-5 meters.

The sensor(s) 12 should be configured to identify obstacles at head level, for example tree branches, and torso level, for example tables. Said identification in one exemplary embodiment may be accomplished by choosing a sensor capable of scanning vertically, or by the user having the ability to aim the sensor.

The sensor(s) 12 should collect data from a wide range of directions. The sensor(s) should return obstacle information from a minimum of a 180 degree view, with the preferred range being 200-270 degrees.

In one exemplary embodiment of the present invention, the headwear 10 also includes the electronic board 32 containing the microprocessor 16 and interface electronics 20 and 30. The interface electronics 20 and 30 connect the microprocessor 16, laser distance scanner 12, and feedback device 22.

In one exemplary embodiment, the feedback device is a tactile user interface consisting of a stimulator array 22. An auditory feedback device may also be used, including, but not limited to, a voice coil. A visual feedback device may also be used, including, but not limited to, any of several types of camera. A variety of tactile feedback devices may also be used, including, but not limited to, vibrating motors, heating devices, cooling devices, bladder devices, or linear actuators.

In one exemplary embodiment, the tactile stimulator array 22 has a coupling 24 to the headwear 10 by means of an elliptical fabric band 26 on the interior of the headwear 10. The coupling 24 is fastened to the headwear 10 by means of element 28. The user has a user interface control 34 to adjust the sensitivity setting of the present invention. The user interface control also comprises, but is not limited to, an accelerometer to detect the angle of the sensor 12. In one exemplary embodiment, the user interface control 34 is coupled to the electronic board 32 via interface electronics 38.

In one exemplary embodiment, the tactile stimulator array 22 is comprised of individual tactile stimulators 36 including, but not limited to, vibrator motors arranged in a vibrating motor array. The vibrator motors are comprised of eccentric rotating mass or ERM motors.

In one exemplary embodiment, the feedback device communicates alerts and information regarding the obstacle to the user using auditory, visual, or tactile means. The obstacle information includes, but is not limited to, presence, direction, distance, size, shape, heat, speed, acceleration, and other characteristics.

In one exemplary embodiment, the direction to an obstacle can be indicated by mapping obstacle direction to particular feedback devices. In this exemplary embodiment, twelve tactile stimulators are mounted in a hat, each stimulator representing 360°/12 or 30° of a sensor's view angle range. An obstacle within +/−15° of straight ahead can be mapped to a stimulator centered in the front of the hat. The mapping need not cover an entire 360°, or even all of the view of the sensor. The mapping does not need to be linear. In one exemplary embodiment, if more resolution is desired for forward viewing angles, smaller sectors can be used for forward views with correspondingly larger sectors in rear views.

In one exemplary embodiment, the distance to the obstacle can be mapped into variations in the stimulus provided by the feedback device to the user. In one exemplary embodiment, information signaling about closer obstacles is delivered by the feedback device first or with more intensity, since this information is more urgent than information about more distant obstacles. If pulse duration is used to communicate obstacle distance, then feedback can be provided in a sequence of time frames.

In one exemplary embodiment, the sectors of a sensor's view range are represented in the code by an array of integers, each of which represent the minimum distance value detected by the sensor in that sector. The distance values of each packet of sensor data are compared with this minimum distance values, and if one of these values is smaller, it is assigned as the new minimum distance value for the sector. The scheduling system for the feedback device consists of five intervals within a time period which correspond to increasing distances. At each interval, the distance values in the array are compared with the distance corresponding to the intervals. The result is that for each time period, such as a second, the first devices to begin providing feedback, including but not limited to ERMs vibrating, will be those devices whose corresponding sectors contained the closest obstacles. As the time period progresses, devices whose sectors contained obstacles at increasingly far distances would begin to provide feedback. Finally, at the end of the time period, all feedback devices will turn off.

In one exemplary embodiment, the distance to an obstacle can be mapped into one of five distance ranges: under 0.25 m, 0.25 m to 0.5 m, 0.5 m to 1 m, and 1 m to 2 m, and beyond 2 m. The time frame is then divided into 5 sub-intervals. In the first sub-interval, no vibrations are present. In the second sub-interval, vibrations corresponding to obstacles within 0.25 m start, and continue to the end of the time frame. In the third sub-interval, vibrations corresponding to obstacles from 0.25 m to 5 m start and continue to the end of the time frame. Similarly, the fourth and fifth sub-intervals correspond to obstacle distances of 0.5 m to 1.0 m and 1.0 m to 2.0 m.

Other quantization intervals may be used in exemplary embodiments of said invention. Distance information may also be encoded in amplitude, pulse width, pulse count, pulse duration, or Morse code in other exemplary embodiments of said invention.

While FIG. 1 illustrates a feedback device using a tactile stimulator array 22 consisting of a number of vibrating motors 36 which can be activated in a variety of patterns, there are numerous alternative feedback devices for exemplary embodiments of the present invention. These alternatives include, but are not limited to: linear resonant actuators, linear actuators, bladders, heating devices, cooling devices, cameras, or voice coils.

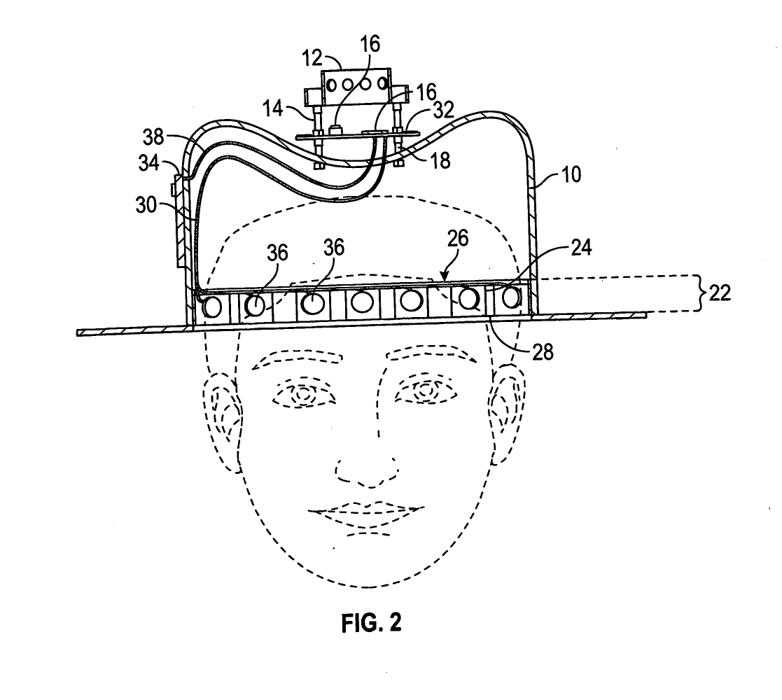

FIG. 2 is a cross-sectional view of one exemplary embodiment of the present invention. A piece of headwear 10 includes a laser distance scanner 12 which is included on the headwear via coupling 14. The headwear 10 also includes the electronic board 32 containing the microprocessor 16 and interface electronics 20 and 30. The interface electronics 20 and 30 connect the microprocessor 16, laser distance scanner 12, and tactile stimulator array 22. The tactile stimulator array 22 has a coupling 24 to the headwear 10 by means of an elliptical fabric band 26 on the interior of the headwear 10. The coupling 24 is fastened to the headwear 10 by means of element 28. The user has a user interface control 34 to adjust the sensitivity setting of the obstacle identification system, which is coupled to the electronic board 32 via interface electronics 38. The tactile stimulator array 22 is composed of individual tactile stimulators 36 including, but not limited to, vibrator motors.

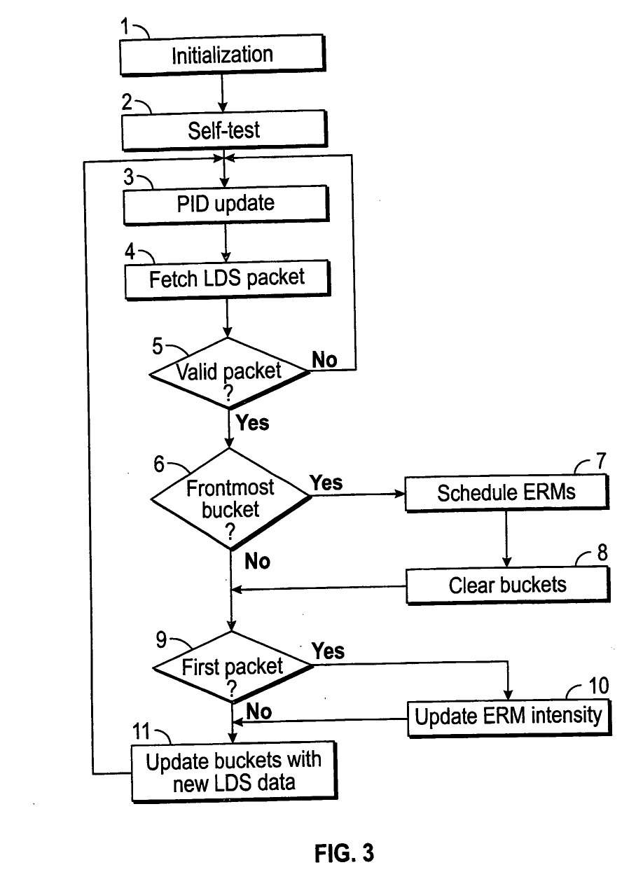

FIG. 3 is a system block diagram of one exemplary embodiment of the present invention.

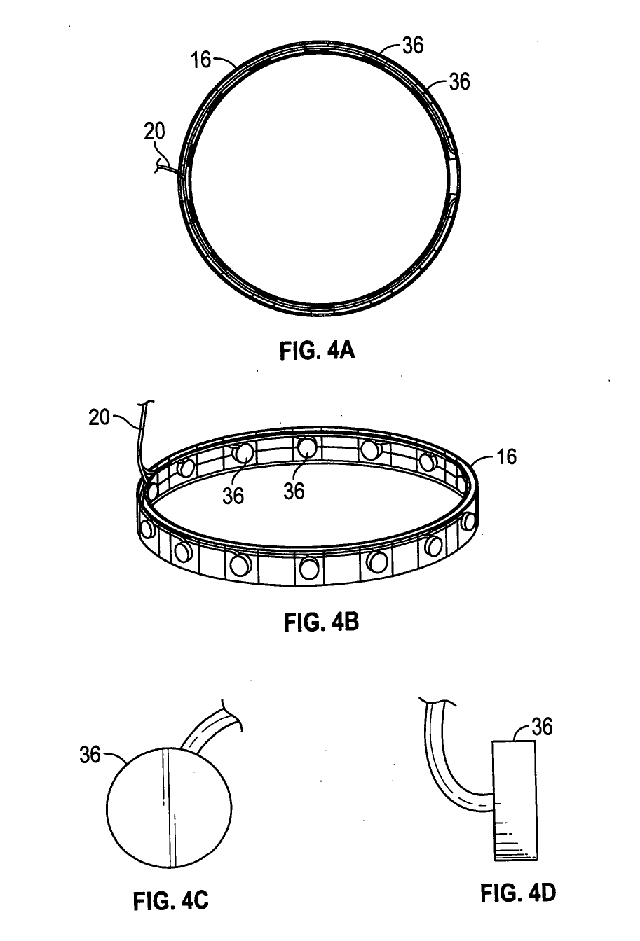

FIG. 4 contains four detailed close-up views of one exemplary embodiment of a feedback device using a tactile stimulator array element in the present invention, including: a top view the tactile stimulator array element 22 in FIG. 4A; a perspective view of the tactile stimulator array element 22 in FIG. 4B; a top view of an individual tactile stimulator 26 in FIG. 4C; and a side view of an individual tactile stimulator 26 in FIG. 4D.

While the obstacle identification system has been described with reference to a specific exemplary embodiment, the description is illustrative of one exemplary embodiment and is not to be construed as limiting. For example, the obstacle identification system is adaptable with a variety of wearable items, sensors, and feedback devices. Thus, various modifications and amplifications may occur to those skilled in the art without departing from the true spirit and scope of the obstacle identification system as defined by the claims herein. The benefits of an obstacle identification system accrue to all users in diverse applications.

1. An obstacle identification system adapted to provide obstacle identification vicinity navigation assistance, comprising:
a sensor for gathering environmental information from the vicinity of a user,
coupled to the sensor, a processing unit, configured to receive said environmental information from the sensor and, when at least one obstacle is present in the vicinity of the user, to generate at least one obstacle distance alert signal, and
coupled to the processor unit, a user interface device, configured to receive said at least one obstacle distance alert signal and to provide obstacle feedback to the user from said at least one obstacle distance alert signal, wherein said system is adapted to be wearable by said user during operation.

2. The obstacle identification system of claim 1, further comprising a wearable item, said item being wearable by said user, wherein at least one of said sensor, said processing unit, and said user interface are coupled with said item of apparel.

3. The obstacle identification system of claim 2, wherein said wearable item comprises an item of headwear.

4. The obstacle identification system of claim 1, wherein said sensor comprises a contactless distance sensor and said environmental information comprises obstacle distance information.

5. The obstacle identification system of claim 4, wherein said sensor is configured to determine at least one of head level obstacle distance information and torso level obstacle distance information.

6. The obstacle identification system of claim 4, wherein said sensor is configured to gather obstacle direction information and, when at least one obstacle is present in the vicinity of the user, said processing unit is configured to provide at least one directional obstacle distance alert signal.

7. The obstacle identification system of claim 1, wherein said sensor comprises a laser distance sensor.

8. The obstacle identification system of claim 7, wherein said laser distance sensor comprises one of a structured light laser sensor and a phase difference laser distance sensor.

9. The obstacle identification system of claim 1, wherein said user interface comprises a non-visual user interface.

10. The obstacle identification system of claim 1, wherein said user interface comprises a tactile user interface.

11. The obstacle identification system of claim 10, wherein said tactile user interface comprises at least one tactile feedback stimulator device, adapted to provide tactile obstacle feedback to the user from said obstacle distance alert signal.

12. The obstacle identification system of claim 11, wherein said at least one tactile feedback stimulator device is configured to provide tactile feedback pulses, wherein the duration of said feedback pulses is set in dependence upon the obstacle distance alert signal.

13. The obstacle identification system of claim 11, wherein said at least one tactile feedback stimulator device is mounted to a wearable item.

14. The obstacle identification system of claim 11, wherein said at least one tactile feedback stimulator device is chosen from the group of tactile feedback stimulator devices consisting of:
a heating device,
a cooling device,
a bladder device,
a vibrating motor, and
a linear actuator.

15. The obstacle identification system of claim 6, wherein said user interface is a tactile user interface and comprises multiple tactile feedback stimulator devices adapted to provide directional tactile obstacle feedback to the user from said directional obstacle distance alert signal.

16. The obstacle identification system of claim 15, wherein:
said multiple tactile feedback stimulator devices are arranged in an array on a wearable item,
each of said tactile feedback stimulator devices is associated with a predefined view angle range,
said tactile user interface is adapted to operate a selected tactile feedback stimulator device from the array of tactile feedback stimulator devices, the selected tactile feedback stimulator device having a predefined view angle range which corresponds to the direction of an obstacle, determined from the at least one directional obstacle distance alert signal.

17. The obstacle identification system of claim 16, wherein at least twelve tactile feedback stimulator devices are arranged in said array, and each of said tactile feedback stimulator devices is associated with a pre-defined view angle of x degrees.

18. An obstacle identification system adapted to provide obstacle identification vicinity navigation assistance, comprising at least:
a contactless distance sensor for obtaining directional obstacle distance information in the vicinity of a user,
coupled to the sensor, a processing unit, configured to receive said directional obstacle distance information and, when at least one obstacle is present in the vicinity of the user, to generate at least one directional obstacle distance alert signal, and
coupled to the processing unit, a user interface device, configured to receive said at least one directional obstacle distance alert signal and to provide directional obstacle feedback to the user from said at least one directional obstacle distance alert signal.

19. A method for providing obstacle identification vicinity navigation assistance, the method comprising the steps of:
obtaining directional obstacle distance information in the vicinity of a user,
generating at least one directional obstacle distance alert signal from said directional obstacle distance information when at least one obstacle is present in the vicinity of the user, and
providing directional obstacle feedback to the user from said at least one directional obstacle distance alert signal.

20. At least one computer-readable medium containing programming instructions that are configured to cause a computing system to provide obstacle identification by performing a method comprising:
obtaining directional obstacle distance information in the vicinity of a user,
generating at least one directional obstacle distance alert signal from said directional obstacle distance information when at least one obstacle is present in the vicinity of the user, and
providing directional obstacle feedback to the user from said at least one directional obstacle distance alert signal.

21. The method of claim 20, wherein said method comprises a feedback device scheduling system, the feedback device scheduling system of which comprises the steps of:
representing the sectors of the sensor's view range in the code by an array of integers, each of which represent the minimum distance value detected by the sensor in that sector,
comparing the distance values of each packet of sensor output with this minimum distance value, and if one of these values is smaller, assigning it as the new minimum distance value for the sector,
establishing five intervals within a time period which correspond to increasing distances,
comparing the distance values in the array with the distance corresponding to the intervals,
scheduling the first devices to begin providing feedback as those devices whose corresponding sectors contain the closest obstacles,
scheduling, as the time period progresses, devices whose sectors contained obstacles at increasingly far distances to begin providing feedback, and
scheduling, at the end of the time interval, the shut down of all feedback devices.
